(19) United States
(12) Patent Application Publication
(10) Pub. No.: US 2019/0197572 A1
(43) Pub. Date: Jun. 27, 2019

(54) STORE SYSTEM

(71) Applicant: KYOCERA Document Solutions Inc., Osaka (JP)

(72) Inventor: Yoshihisa SHINTANI, Osaka (JP)

(73) Assignee: KYOCERA Document Solutions Inc., Osaka (JP)

(21) Appl. No.: 16/226,961

(22) Filed: Dec. 20, 2018

(30) Foreign Application Priority Data
Dec. 27, 2017 (JP) 2017-252167

(51) Int. Cl. G06Q 30/02; G06Q 10/08

(52) U.S. Cl. CPC G06Q 30/0223; G06K 19/06037; G06Q 10/087

(57) ABSTRACT

A store system includes a server and a customers' terminal. The server includes: an inventory management section; a promotional product designating section that, based on inventory statuses of products, designates a promotional product; a recipe database that stores data on a plurality of recipes using, as ingredients, products available for sale in a store; and a promotional product-related recipe designating section that designates, among the plurality of recipes, a recipe using as an ingredient the promotional product as a promotional product-related recipe. The customers' terminal includes: a display, an operating section; a printing section; a recipe display control section that acquires data on the promotional product-related recipe from the server and allows the display to display a recipe using the promotional product much; and a recipe print control section that, upon request to print out any recipe from a customer, allows the printing section to print out the recipe.

### INCORPORATION BY REFERENCE

This application claims priority to Japanese Patent Application No. 2017-252167 filed on Dec. 27, 2017, the entire contents of which are incorporated by reference herein.

### BACKGROUND

The present disclosure relates to store systems and particularly relates to a technique for promoting the sale of a product designated as a promotional product.

Some supermarkets, department stores, and the like are provided with in-store customers' terminals freely available to customers. The customers can use the customers' terminals to view information on products and events or get necessary information in the form of printed copies on paper. For example, there is a product sales price calculation system in which products necessary for cooking a dish indicated in a recipe sheet printed out by an image forming apparatus placed in a store are priced down to increase the effect of pulling in more customers.

### SUMMARY

A technique improved over the above technique is proposed herein as one aspect of the present disclosure.

A store system according to an aspect of the present disclosure is a store system including a server and a customers' terminal. The server includes an inventory management section, a promotional product designating section, a recipe database, and a promotional product-related recipe designating section. The inventory management section manages inventory of products for sale in a store. The promotional product designating section designates one or more promotional products based on inventory statuses of the products being managed by the inventory management section. The recipe database stores data on a plurality of recipes using, as ingredients, products available for sale in the store. The promotional product-related recipe designating section designates, among the plurality of recipes stored as data in the recipe database, a recipe using as an ingredient any of the promotional products designated by the promotional product designating section as a promotional product-related recipe. The customers' terminal includes a display, an operating section, a printing section, a recipe display control section, and a recipe print control section. The display displays various information. The operating section accepts an operation from a customer. The printing section prints an image on a sheet. The recipe display control section acquires data on the promotional product-related recipe from the server and allows the display to display a recipe containing the promotional product first. The recipe print control section responds to an instruction to print out any recipe, the instruction being input through the operating section by the customer, to allow the printing section to print out the recipe.

### BRIEF DESCRIPTION OF THE DRAWINGS

FIG. 1 is a schematic configuration diagram of a store system according to an embodiment of the present disclosure.

FIG. 2 is a block diagram showing the configuration of essential components of a server.

FIG. 3 is a block diagram showing the configuration of essential components of a customers' terminal.

FIG. 4A is a flowchart for illustrating an operation example of the store system.

FIG. 4B is a continuation of the flowchart of FIG. 4A and a flowchart for illustrating the operation example of the store system.

FIG. 5 is a view showing an example of a screen image of a promotional product-related recipe displayed on the customers' terminal.

FIG. 6 is a view showing an example of a screen image of discount information on a promotional product displayed on the customers' terminal.

FIG. 7 is a view showing a print example of the promotional product-related recipe.

FIG. 8A is a flowchart for illustrating another operation example of the store system.

FIG. 8B is a continuation of the flowchart of FIG. 8A and a flowchart for illustrating the other operation example of the store system.

### DETAILED DESCRIPTION

Hereinafter, a description will be given of a store system according to one embodiment of the present disclosure with reference to the drawings. For convenience, the following description takes as an example a store system introduced for a supermarket.

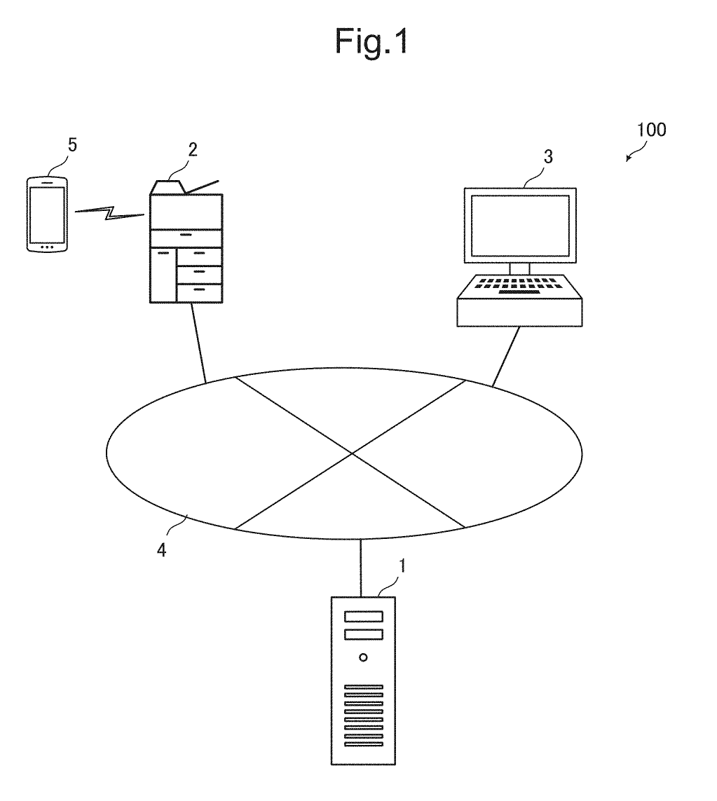

FIG. 1 is a schematic configuration diagram of a store system according to one embodiment of the present disclosure. A store system 100 according to the one embodiment of the present disclosure includes at least a server 1 and a customers' terminal 2. In this embodiment, a description will be given of the case where the store system 100 further includes a POS terminal (cash register terminal) 3. The server 1, the customers' terminal 2, and the POS terminal 3 are connected by wire or wirelessly to a network 4, such as a LAN (local area network), and can thus communicate with each other.

The server 1 is a computer for managing inventory of products for sale in a store. The server 1 is placed at a location out of customers' sight, such as a store office. Alternatively, the server 1 may be placed at a remote location or in a cloud.

The customers' terminal 2 is a terminal placed in a store front and freely operable by the customers and is, for example, an image forming apparatus. The customers' terminal 2 operates so that the customers can view therethrough various information, including recommendation of foods available for sale in the store and recipes for dishes cookable using the foods, and prints the information on sheets as needed. Furthermore, as will be described hereinafter, the customers' terminal 2 performs close proximity wireless communications with a user terminal 5, such as a smartphone or a tablet terminal, carried by a customer to acquire photographic data on a dish from the user terminal 5.

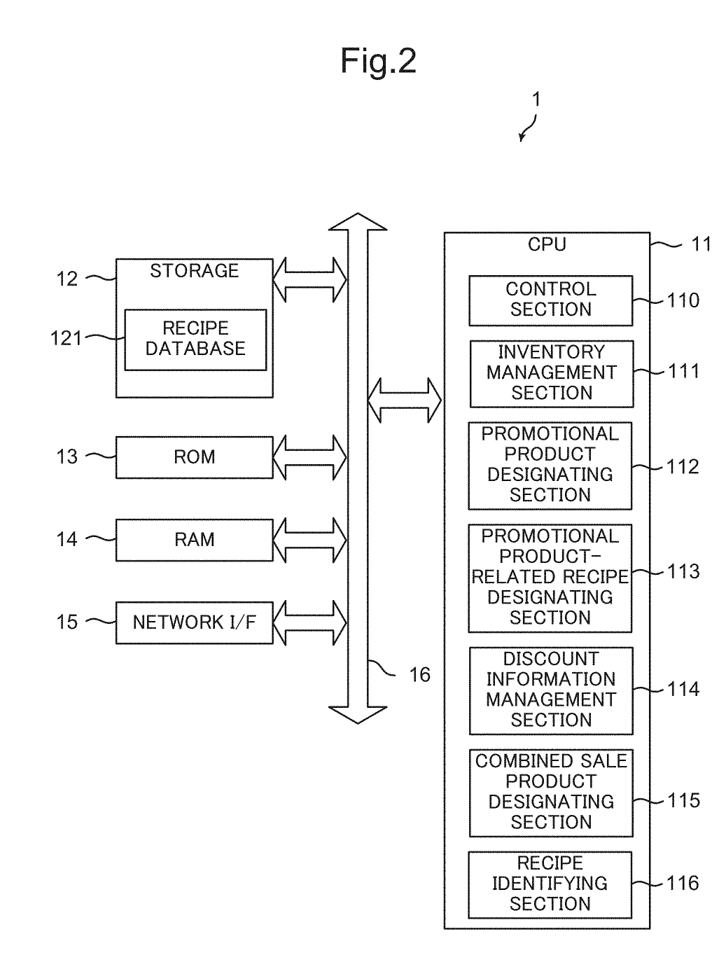

FIG. 2 is a block diagram showing the configuration of essential components of the server 1. The server 1 includes a CPU (central processing unit) 11, a storage 12, a ROM (read only memory) 13, a RAM (random access memory) 14, a network interface 15, and so on. These components are connected to each other via an internal bus 16.

The CPU 11 operates in accordance with a management program stored, for example, in the storage 12 to function as a control section 110, an inventory management section 111, a promotional product designating section 112, a promotional product-related recipe designating section 113, a discount information management section 114, a combined sale product designating section 115, and a recipe identifying section 116. Alternatively, each of these sections may not be implemented as a function of the CPU 11 but may be constituted by hardware.

The storage 12 is constituted by a hard disk drive (HDD), a solid state drive (SSD) or the like and stores an operating system and various types of application software each run on the CPU 11, the above management program, system files, data files, and so on.

A recipe database 121 is provided on the storage 12. The recipe database 121 stores data on a plurality of recipes using, as ingredients, products available for sale in the store. The CPU 11 accepts, by remote control of the server 1, for example, using an unshown management terminal (information processing device), a manager's instruction to perform the deletion or amendment of an existing recipe in the recipe database 121 or the addition of a new recipe to the recipe database 121 and performs, according to the instruction, the deletion or amendment of the existing recipe in the recipe database 121 or the addition of the new recipe to the recipe database 121.

The ROM 13 stores a program, such as BIOS, to be run when the server 1 starts.

The RAM 14 functions as a working memory when the CPU 11 runs an operating system or various types of application software, and the RAM 14 temporarily stores data for use in various programs.

The network interface 15 is connected to the network 4 (see FIG. 1) and communicates with the customers' terminal 2 and the POS terminal 3.

The control section 110 governs the overall operation control of the server 1.

The inventory management section 111 stores data on inventory of products for sale in the store. When the manager inputs the date of arrival, quantity, price or others of each product through the above management terminal to the inventory management section 111, the inventory management section 111 saves the input data to the storage 12.

Furthermore, when processing for purchase of a product is executed on the POS terminal 3, the inventory management section 111 acquires data on the processing for purchase from the POS terminal 3 and updates inventory data on the product.

The promotional product designating section 112 designates one or more promotional products based on the inventory statuses of products. The promotional product refers to a product that the store wants to preferentially put on sale. For example, the promotional product designating section 112 treats products purchased in volume, large stocks of products selling slowly, and short-life perishable products as promotional products. The promotional product designating section 112 refers to data on inventory being managed by the inventory management section 111 and, based on this inventory data, designates large stocks of products and products keeping poor performance in selling for a long term as promotional products. Alternatively, the promotional product designating section 112 designates a promotional product according to a manager's instruction through the management terminal.

The promotional product-related recipe designating section 113 designates, among the plurality of recipes stored in the recipe database 121, a recipe using as an ingredient any of the promotional products designated by the promotional product designating section 112 as a promotional product-related recipe. If a plurality of promotional products are designated by the promotional product designating section 112, the promotional product-related recipe designating section 113 designates a recipe containing at least one of the promotional products as a promotional product-related recipe.

The discount information management section 114 stores discount information on each promotional product. The discount information refers to a discount rate or a discount price. The manager determines the discount rate or discount price for each promotional product and sends the determined discount information through the management terminal to the discount information management section 114. Then, the discount information management section 114 stores the discount information.

The combined sale product designating section 115 designates, as a combined sale product, a product for compensating for the loss of a nutrient in the promotional product-related recipe. Specifically, each recipe stored in the recipe database 121 contains, as preliminary information, a radar chart representing respective contents of nutrients contained in a dish to be cooked from the recipe. The combined sale product designating section 115 refers to the radar chart to identify a nutrient in which the promotional product-related recipe is deficient, and picks up a product, or food, rich in the nutrient from among products available for sale in the store, for example, based on the inventory statuses of the on-sale products the inventory data on which the inventory management section 111 stores. When possible, the combined sale product designating section 115 selects the combined sale product from among the promotional products. In other words, if the promotional products include a product for compensating for the loss of a nutrient in the promotional product-related recipe, the combined sale product designating section 115 designates the product for compensating for the loss of a nutrient in the promotional product-related recipe as the combined sale product.

The recipe identifying section 116 identifies, from among the plurality of recipes stored in the recipe database 121, a recipe corresponding to a dish photograph transmitted from the customers' terminal 2. Specifically, each recipe stored in the recipe database 121 contains, as preliminary information, a photograph of a dish to be cooked from the recipe.

The recipe identifying section 116 performs processing of image matching between the photograph as the preliminary information and the dish photograph received from the customers' terminal 2 to identify a recipe corresponding to the received dish photograph from among the plurality of recipes stored in the recipe database 121.

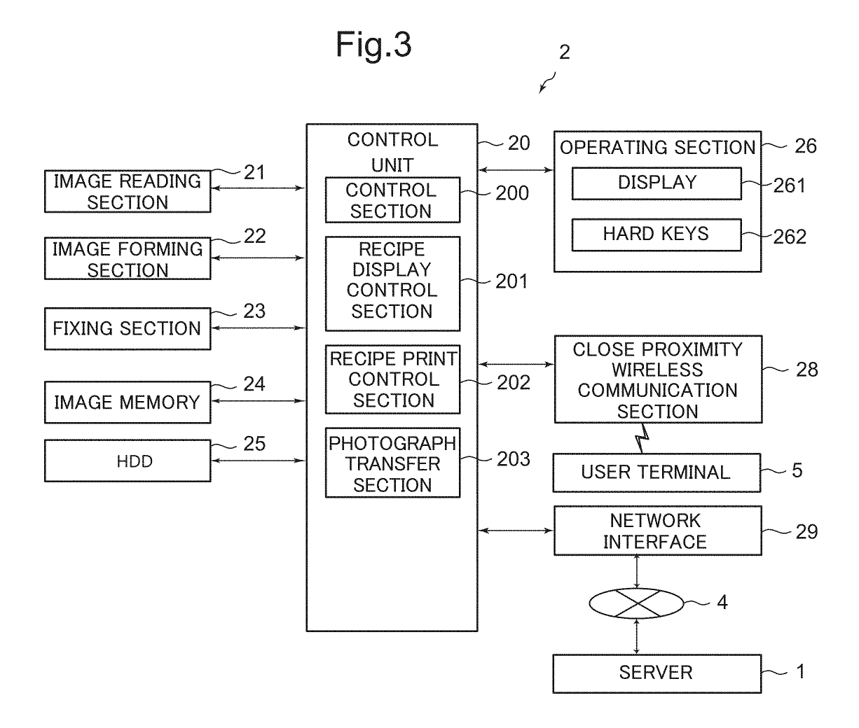

FIG. 3 is a block diagram showing the configuration of essential components of the customers' terminal 2. The customers' terminal 2 is, for example, a multifunction peripheral (MFP) in which functions as a printer, a facsimile machine, and a scanner are integrated.

An image reading section 21 is under the control of a control unit 20 and includes a scanning mechanism including a lighting part, a CCD sensor, and so on. The image reading section 21 reads a document image from an original document by irradiating the document with light from the lighting part and receiving the reflected light on the CCD sensor.

An image forming section 22 forms an image of document image data obtained by reading by the image reading section 21, print data received from the network-connected server 1, or like data.

A fixing section 23 performs fixation processing for heating a recording paper sheet on a surface of which an image (toner image) is formed by image formation processing of the image forming section 22, and fixing the image on the sheet by the application of heat and pressure.

The image forming section 22 and the fixing section 23 correspond to the “printing section” defined in What is claimed is.

An image memory 24 provides a region for temporarily storing the document image acquired by reading by the image reading section 21 and temporarily saving an image to be subjected to the image formation processing by the image forming section 22.

An HDD 25 is a large storage device capable of storing document image data obtained by reading by the image reading section 21, print data received from the server 1, photograph data received from the user terminal 5, or the like.

An operating section 26 accepts users' (customers') instructions for various types of operations and processing executable by the customers' terminal 2. The operating section 26 includes: a touch panel-type display 261 that displays various information; and a plurality of hard keys 262.

A close proximity wireless communication section 28 is constituted by a communication system that performs close proximity wireless communications with the user terminal 5 by Bluetooth (registered trademark) or NFC (Near Field Communication).

A network interface 29 is constituted by a communication module, such as a LAN board, and transfers various data, via a LAN or the like connected to the network interface 29, to and from the server 1 connected to the network 4.

The control unit 20 is composed of a processor, a RAM, a ROM, a dedicated hardware circuit, and so on. The processor is, for example, a CPU, an MPU or an ASIC. The control unit 20 includes a control section 200, a recipe display control section 201, a recipe print control section 202, and a photograph transfer section 203. A control program is stored on the HDD 25 or in the aforementioned ROM. The control unit 20 operates according to the control program to serve as the control section 200, the recipe display control section 201, the recipe print control section 202, and the photograph transfer section 203. Alternatively, instead of following the control program, the control unit 20 may include as hardware circuits the control section 200, the recipe display control section 201, the recipe print control section 202, and the photograph transfer section 203.

The control section 200 governs the overall operation control of the customers' terminal 2, is connected to the image reading section 21, the image forming section 22, the fixing section 23, the image memory 24, the HDD 25, the operating section 26, and so on, and controls the operations of these components.

The recipe display control section 201 acquires data on promotional product-related recipe from the server 1 and allows the display 261 to display a promotional product-related recipe. If the data on promotional product-related recipe indicates a plurality of promotional product-related recipes, the recipe display control section 201 allows the display 261 to display a recipe containing a promotional product first and preferably allows the display 261 to display a recipe containing a large number of promotional products first.

When a customer makes a request to print any recipe through the operating section 26, the recipe print control section 202 controls the image forming section 22 and the fixing section 23 to allow them to print out the recipe.

The store promotes the sale of the promotional product by presenting the recipe using the promotional product to the customer in the above manner.

Furthermore, when a customer inputs an instruction to select any recipe through the operating section 26, the recipe display control section 201 follows the instruction, thus acquiring discount information on one of promotional products contained in the selected recipe from the server 1 and allowing the display 261 to display the discount information.

When the customer inputs an instruction to print out the recipe through the operating section 26, the recipe print control section 202 follows the print instruction, thus controlling the image forming section 22 and the fixing section 23 to allow them to print, together with the selected recipe, a discount code for the promotional product based on the discount information. The discount code is, for example, a bar code or a QR code (registered trademark). The discount code is read by the POS terminal 3, so that the customer can purchase the promotional product at a discount price.

The store promotes the sale of the promotional product by printing a discount code for the promotional product in combination with a recipe desired by the customer in the above manner.

Moreover, when the customer inputs an instruction requesting discount information on another product through the operating section 26, the recipe display control section 201 may follow the instruction, thus acquiring discount information on another promotional product contained in the selected recipe from the server 1 and allowing the display 261 to display, in place of the discount information previously displayed on the display 261, the newly acquired discount information on the other promotional product. Hence, even if the customer already gets the promotional product recommended for purchase at a discount price by the store and need not purchase it, the store can promote the sale of another promotional product by presenting a discount of the other promotional product to the customer.

Furthermore, when the customer selects any recipe through the operating section 26, the recipe display control section 201 may acquire information on a combined sale product related to the recipe from the server 1 and allow the display 261 to display the information on the combined sale product together with the recipe. In this manner, the store promotes the sale of products so that the combined sale product can be purchased in a bundle with the promotional product.

Suppose that a customer has already decided what dish to cook and has a photograph of the dish on his/her user terminal 5. In this case, the photograph transfer section 203 acquires data of the dish photograph through the close proximity wireless communication section 28 from the user terminal 5. When acquiring the data of the dish photograph from the user terminal 5, the photograph transfer section 203 transmits the data through the network interface 29 to the server 1. In the server 1, as described previously, the recipe identifying section 116 identifies a recipe corresponding to the dish photograph. Then, the recipe display control section 201 of the customers' terminal 2 acquires the identified recipe from the server 1 and allows the display 261 to display the recipe. Thus, so long as the customer has a photograph of a dish that he/she intends to cook, even if not knowing its recipe, the recipe can be presented to the customer. In this manner, the store can promote the sale of the promotional product.

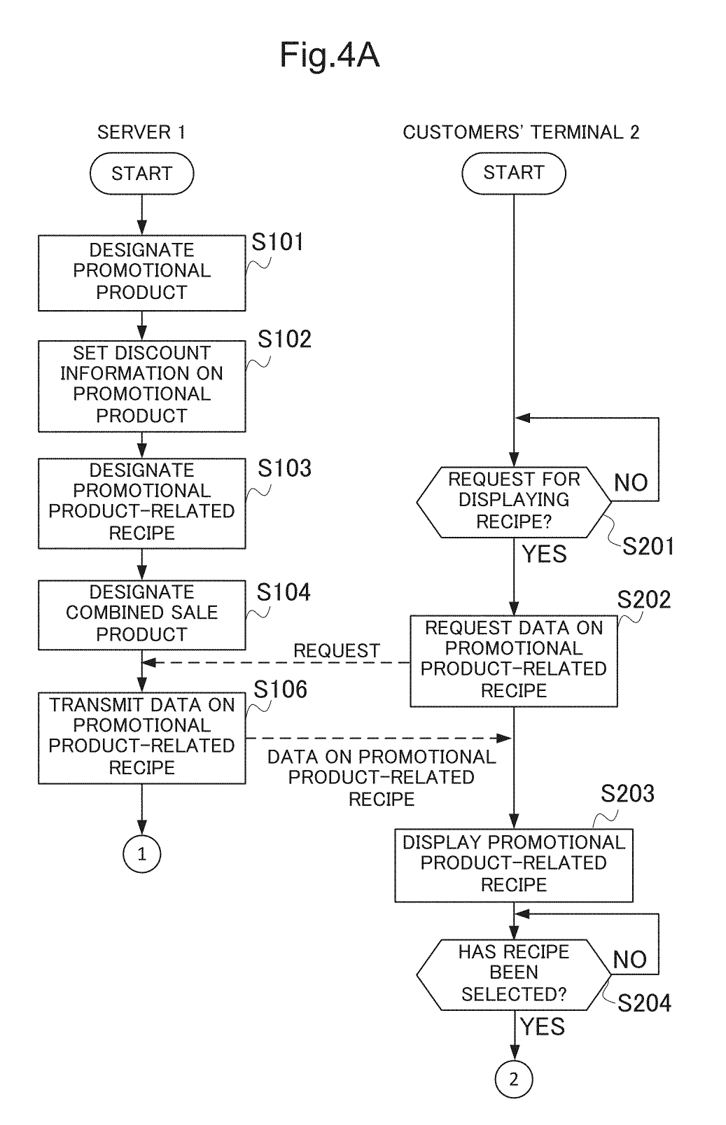

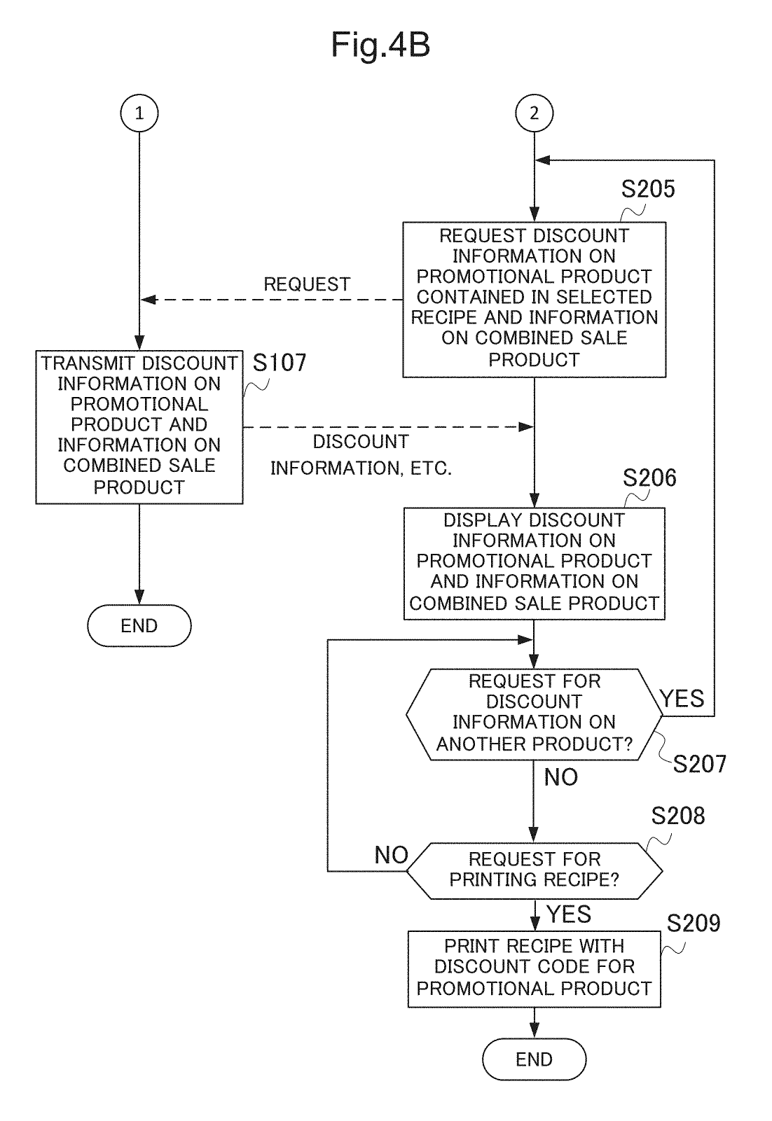

Next, a description will be given of an operation of the store system 100. FIGS. 4A and 4B are flowcharts for illustrating an operation example of the store system 100.

First, in the server 1, the promotional product designating section 112 refers to data on inventory being managed by the inventory management section 111 and designates promotional products based on the inventory statuses of products (S101).

When the promotional products are designated, the discount information management section 114 determines discount information on the promotional products (S102).

Furthermore, the promotional product-related recipe designating section 113 designates, among a plurality of recipes stored in the recipe database 121, one or more recipes using as an ingredient any promotional product designated by the promotional product designating section 112 as promotional product-related recipes (S103).

Moreover, the combined sale product designating section 115 designates, as a combined sale product, a product for compensating for the loss of a nutrient in each of the promotional product-related recipes (S104). In doing so, the combined sale product designating section 115 gives priority to the promotional products and designates an appropriate one of these promotional products as the combined sale product. The execution sequence from S102 to S104 may be changed.

Then, when a customer operates the operating section 26 of the customers' terminal 2 to input an instruction requesting to display a recipe (YES in S201), the recipe display control section 201 requests, according to the instruction, the server 1 to transmit data on the promotional product-related recipes (S202). In response to the request, the control section 110 of the server 1 reads the data on the promotional product-related recipes from the recipe database 121 and transmits the data through the network interface 15 to the customers' terminal 2 (S106). The recipe display control section 201 receives the data on the promotional product-related recipes from the server 1 and allows the display 261 to display the promotional product-related recipes (S203).

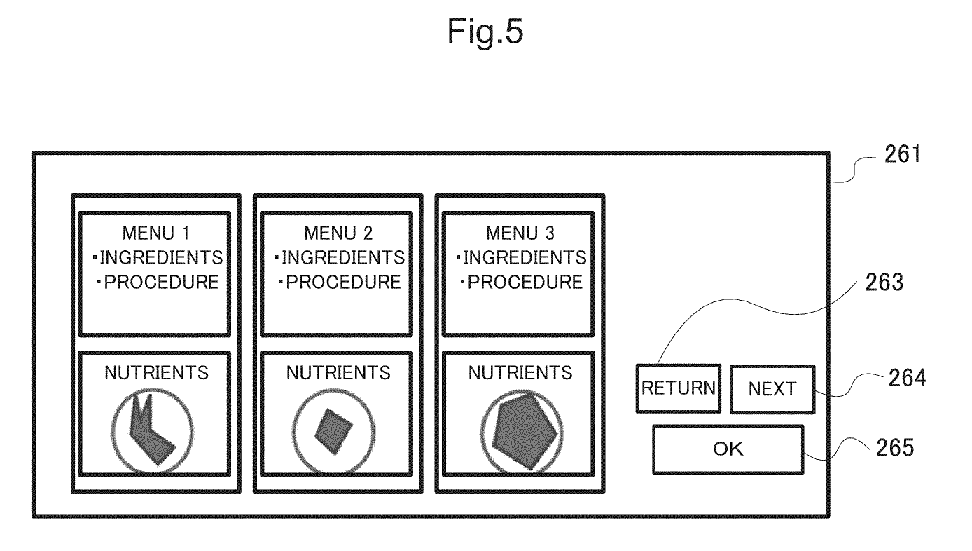

FIG. 5 is a view showing an example of a screen image of a promotional product-related recipe displayed on the customers' terminal 2. In the example of FIG. 5, three recipes are displayed. Each recipe contains a radar chart representing various nutrients of a dish to be cooked from the recipe. For convenience of the screen size of the display 261, all of promotional product-related recipes received from the server 1 may not necessarily be displayed on the display 261 at once. If there is a large number of promotional product-related recipes, the customer may appropriately make a touch gesture on a “Return” button 263 or a “Next” button 264 on the screen to input an instruction to display a previous screen or a next screen through a touch panel provided in the display 261. According to the instruction, the recipe display control section 201 allows the display 261 to display another or other recipes on the previous screen or the next screen. Thus, the customer can look for a desired recipe. Furthermore, when finding the desired recipe, the customer makes a touch gesture on the recipe to select the recipe and then makes a touch gesture on an “OK” button 265. Thus, an instruction to display the details of the recipe is input through the touch panel and the recipe display control section 201 according to the instruction allows the display 261 to display the details of the selected recipe.

Referring back to FIG. 4A, when during display of the promotional product-related recipes the customer operates the operating section 26 to select any recipe from among the displayed recipes (YES in S204), the recipe display control section 201 makes a transmission request to the server 1 to transmit discount information on any promotional product contained in the selected recipe and information on any combined sale product (S205). When receiving the transmission request through the network interface 15, the control section 110 of the server 1 follows the request, thus acquiring discount information on any promotional product and information on any combined sale product from the discount information management section 114 and the combined sale product designating section 115, respectively, and transmitting these pieces of information through the network interface 15 to the customers' terminal 2 (S107). The recipe display control section 201 of the customers' terminal 2 receives the discount information on the promotional product and the information on the combined sale product through the network interface 29 from the server 1 and allows the display 261 to display these pieces of information (S206).

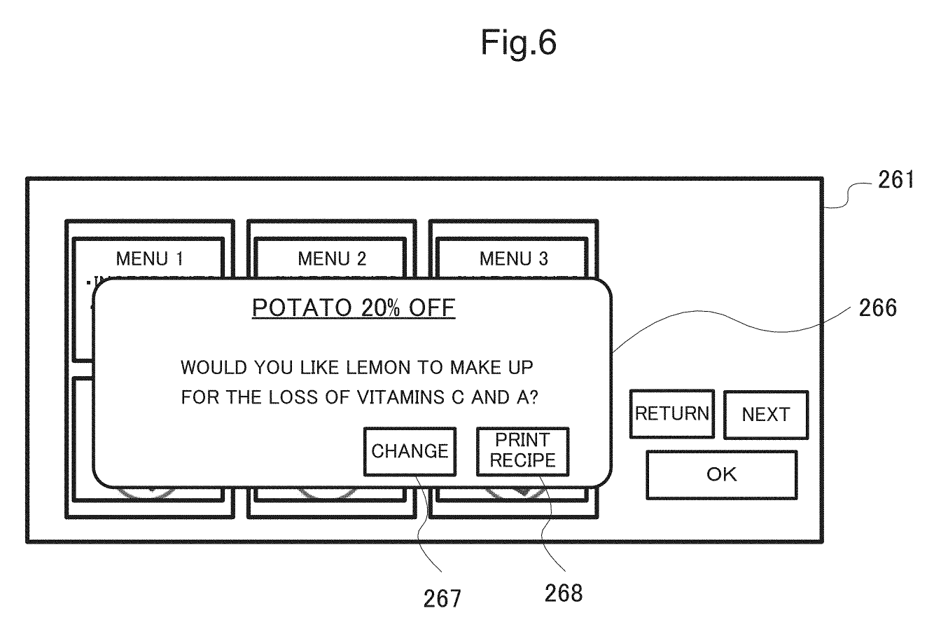

FIG. 6 is a view showing an example of a screen image of discount information on a promotional product displayed on the customers' terminal 2. In the example of FIG. 6, the promotional product is “POTATO” and the combined sale product is “LEMON”. The recipe display control section 201 allows the display 261 to display a pop-up window 266 to present the discount information on the promotional product and the information on the combined sale product to the customer. When the customer makes a touch gesture on a “Change” button 267 in the pop-up window 266, an instruction requesting discount information on another product is input through the touch panel. Alternatively, when the customer makes a touch gesture on a “Print Recipe” button 268 in the pop-up window 266, an instruction to print out the recipe is input through the touch panel.

Referring back to FIG. 4B, when the customer makes a gesture for requesting discount information on another product in the above manner (YES in S207), the recipe display control section 201 requests the server 1 through the network interface 29 to transmit discount information on another product (S205). In doing so, the recipe display control section 201 requests the server 1 to transmit discount information on another promotional product contained in the recipe selected by the customer.

In response to the request, the control section 110 of the server 1 acquires discount information on another promotional product from the discount information management section 114 and transmits it to the customers' terminal 2 (S107). The recipe display control section 201 of the customers' terminal 2 receives the discount information on the promotional product from the server 1 and allows the display 261 to display the information (S206).

To avoid the customer requesting a change of discount information over and over, the recipe display control section 201 may set a ceiling on the number of requests for the change of discount information. For example, the recipe display control section 201 may restrict the number of requests for the change of discount information to once.

When the customer operates the operating section 26 to input an instruction requesting a print-out of the recipe (YES in S208), the recipe print control section 202 follows the instruction, thus controlling the image forming section 22 and the fixing section 23 to allow them to print, together with the selected recipe, a discount code for the promotional product based on the discount information (S209).

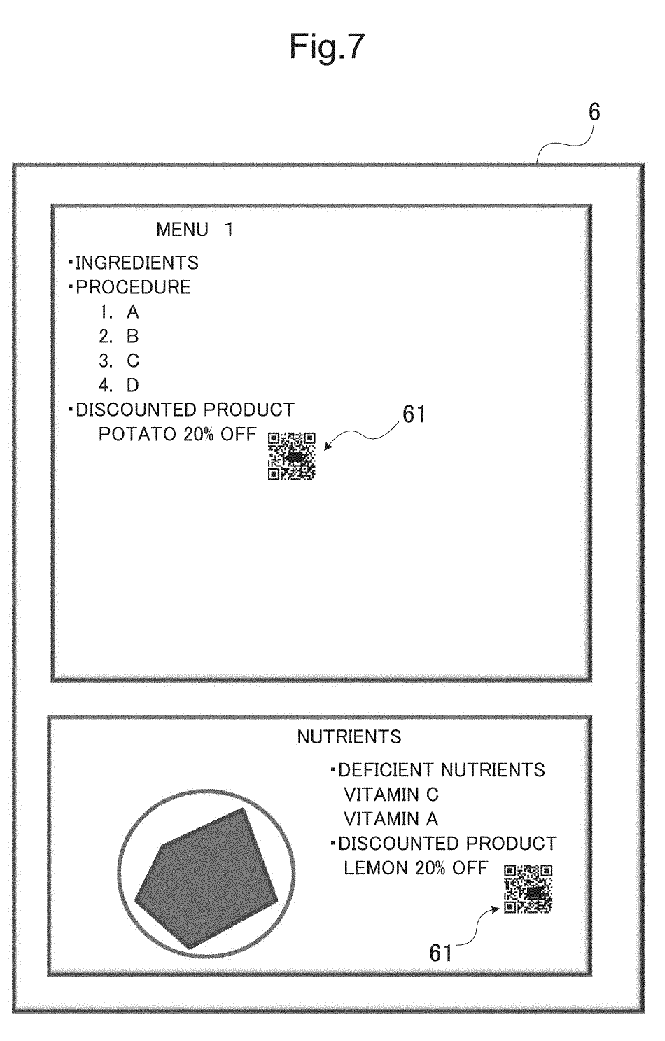

FIG. 7 is a view showing a print example of the promotional product-related recipe. A recipe sheet 6 shown in FIG. 7 is an example of a recipe printed when the customer makes a touch gesture on the “Print Recipe” button 268 in the pop-up window 266 shown in FIG. 6. In addition to the recipe selected by the customer, a discount code 61 for “POTATO” which is a promotional product is also printed on the recipe sheet 6. A discount code 61 for “LEMON” which is a combine sale product is also printed. The discount codes 61 are read by the POS terminal 3, so that the customer can purchase the promotional product and the combined sale product at discount prices.

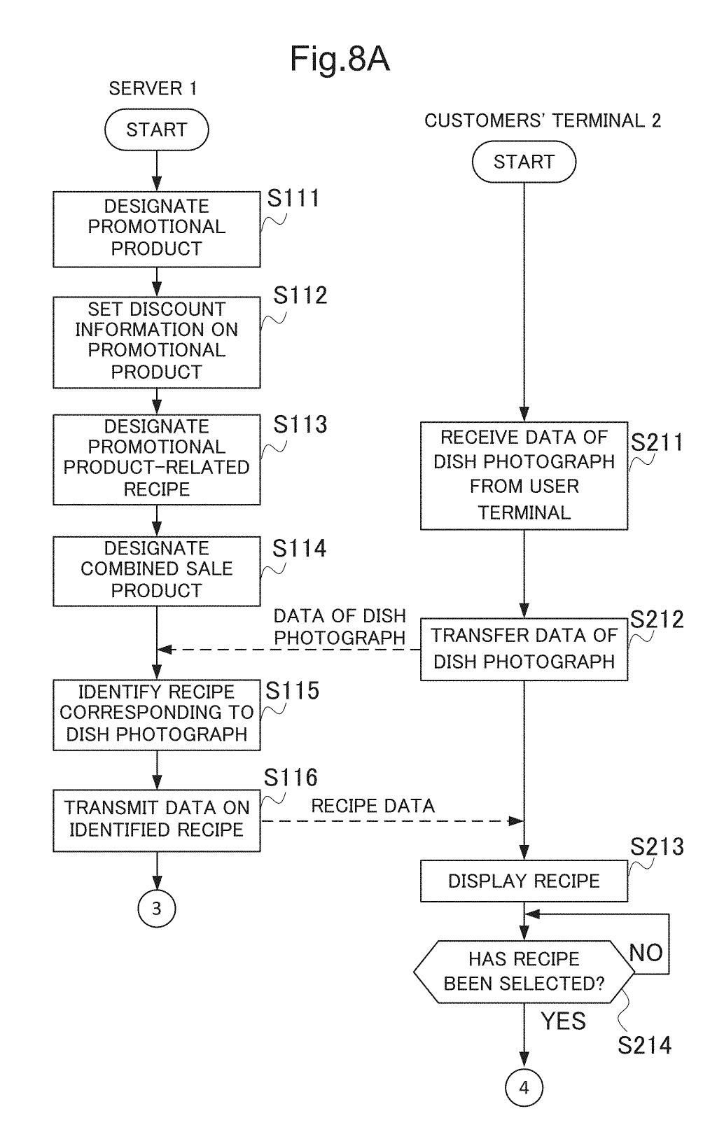

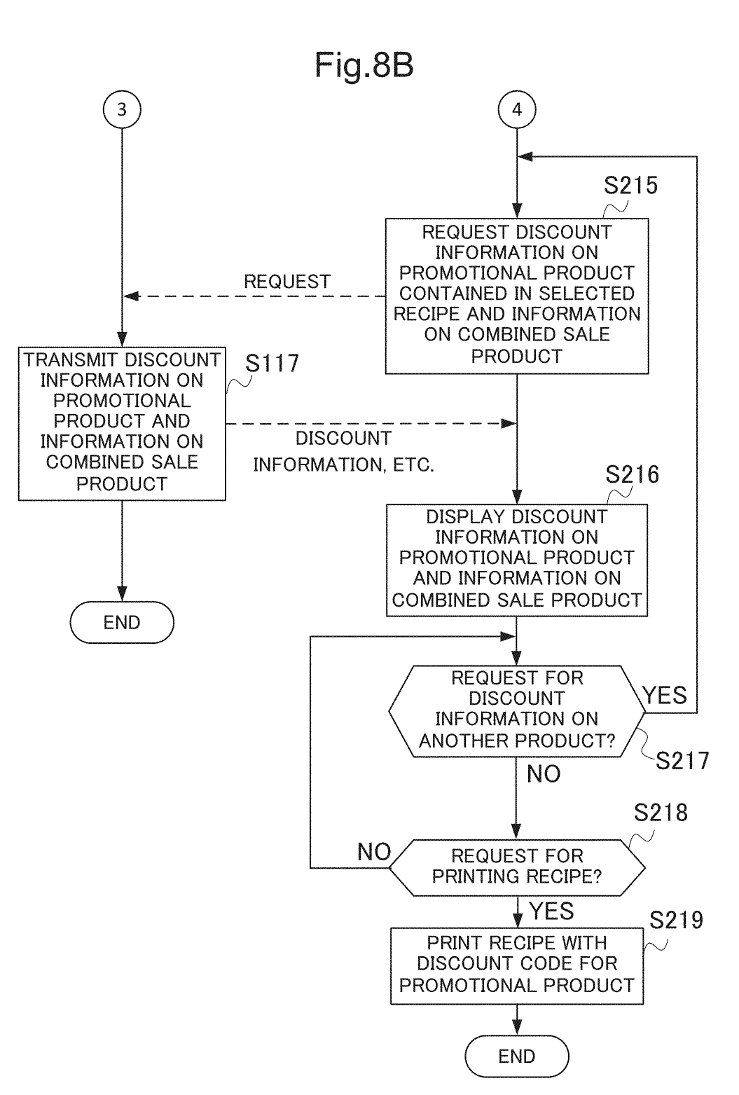

FIGS. 8A and 8B are flowcharts for illustrating another operation example of the store system 100.

First, in the server 1, the promotional product designating section 112 refers to data on inventory being managed by the inventory management section 111 and designates promotional products based on the inventory statuses of products (S111).

When the promotional products are designated, the discount information management section 114 determines discount information on the promotional products (S112).

Furthermore, the promotional product-related recipe designating section 113 designates, among a plurality of recipes stored in the recipe database 121, one or more recipes using as an ingredient any promotional product designated by the promotional product designating section 112 as promotional product-related recipes (S113).

Moreover, the combined sale product designating section 115 designates, as a combined sale product, a product for compensating for the loss of a nutrient in each of the promotional product-related recipes (S114). In doing so, the combined sale product designating section 115 gives priority to the promotional products and designates an appropriate one of these promotional products as the combined sale product. The execution sequence from S112 to S114 may be changed.

Then, when a customer sends data of a dish photograph stored in his/her user terminal 5 from the user terminal 5 to the customers' terminal 2, the photograph transfer section 203 of the customers' terminal 2 receives the data of the dish photograph through the close proximity wireless communication section 28 (S211) and transfers it through the network interface 29 to the server 1 (S212).

When receiving the data of the dish photograph through the network interface 15, the recipe identifying section 116 of the server 1 identifies, from among the plurality of recipes stored in the recipe database 121, a recipe corresponding to the dish photograph transmitted from the customers' terminal 2 (S115) and transmits data on the identified recipe through the network interface 15 to the customers' terminal 2 (S116). The recipe display control section 201 receives the data on the recipe through the network interface 29 from the server 1 and allows the display 261 to display the recipe (S213).

When the customer operates the operating section 26 to input an instruction to select the displayed recipe (YES in S214), the recipe display control section 201 transmits, through the network interface 29 to the server 1, an instruction of a request for discount information on any promotional product contained in the selected recipe and information on any combined sale product (S215).

When receiving the request, the control section 110 of the server 1 acquires discount information on any promotional product and information on any combined sale product from the discount information management section 114 and the combined sale product designating section 115, respectively, and transmits these pieces of information to the customers' terminal 2 (S117). The recipe display control section 201 receives the discount information on the promotional product and the information on the combined sale product from the server 1 and allows the display 261 to display these pieces of information (S216).

When the customer operates the operating section 26 of the customers' terminal 2 to input an instruction requesting discount information on another product (YES in S217), the recipe display control section 201 transmits to the server 1, according to the instruction, a request for discount information on another product (S215). In doing so, if the recipe selected by the customer contains another promotional product, the recipe display control section 201 transmits to the server 1 a request for discount information on the other promotional product.

In response to the request, the control section 110 of the server 1 acquires discount information on the other promotional product from the discount information management section 114 and transmits it to the customers' terminal 2 (S117). The recipe display control section 201 receives the discount information on the promotional product from the server 1 and allows the display 261 to display the information (S216).

The recipe display control section 201 may set a ceiling on the number of requests for a change of discount information in order to avoid the customer requesting the change of discount information over and over. For example, the recipe display control section 201 may restrict the number of requests for the change of discount information to once.

When the customer operates the operating section 26 to input an instruction requesting a print-out of the recipe (YES in S218), the recipe print control section 202 follows the instruction, thus controlling the image forming section 22 and the fixing section 23 to allow them to print, together with the selected recipe, a discount code for the promotional product based on the discount information (S219).

As thus far described, according to this embodiment, large stocks of products, short-life products and so on are designated as promotional products based on the inventory statuses of products and discount information on the promotional products is presented, together with recipes, through the customer's terminal 2 to customers. Thus, the store can promote the sale of the promotional products.

The store has a circumstance that it wants to actively sell large stocks of products and short-life products. The store designates such products as promotional products and sells them at discount prices, thus promoting the sale of them and concurrently increasing the effect of pulling in more customers. The product sales price calculation system described in BACKGROUND above can increase the effect of pulling in more customers by discounting products necessary for cooking a dish described in a recipe sheet printed out by the image forming apparatus placed in the store, but does not contribute to the sales improvement of the above promotional products.

Unlike the above, in this embodiment, the sale of the promotional products can be improved.

Although the above description has been given of the example where the store system 100 is applied to a supermarket, the range of application of the store system according to the present disclosure is not limited to such a supermarket. Furthermore, the recipe is not limited to a recipe for a dish and, for example, may be a fabrication procedure for a piece of furniture or the like to be made by doing DIY. In this case, the store system according to the present disclosure is applied to a home improvement center or like store.

The structure, configuration, and processing shown in the above embodiment with reference to FIGS. 1 to 8B are merely illustrative of the present disclosure and the present disclosure is not intended to be limited to the above structure, configuration, and processing.

While the present disclosure has been described in detail with reference to the embodiments thereof, it would be apparent to those skilled in the art the various changes and modifications may be made therein within the scope defined by the appended claims.

What is claimed is:

1. A store system comprising a server and a customers' terminal,
the server comprising:
an inventory management section that manages inventory of products for sale in a store;
a promotional product designating section that designates one or more promotional products based on inventory statuses of the products being managed by the inventory management section;
a recipe database that stores data on a plurality of recipes using, as ingredients, products available for sale in the store; and
a promotional product-related recipe designating section that designates, among the plurality of recipes stored as data in the recipe database, a recipe using as an ingredient any of the promotional products designated by the promotional product designating section as a promotional product-related recipe,
the customers' terminal comprising:
a display that displays various information;
an operating section that accepts an operation from a customer;
a printing section that prints an image on a sheet;
a recipe display control section that acquires data on the promotional product-related recipe from the server and allows the display to display a recipe containing the promotional product first; and
a recipe print control section that responds to an instruction to print out any recipe, the instruction being input through the operating section by the customer, to allow the printing section to print out the recipe.

2. The store system according to claim 1, wherein
the server further comprises a discount information management section that manages discount information on the one or more promotional products,
when the customer selects any recipe through the operating section, the recipe display control section of the customers' terminal acquires the discount information on one of the promotional products contained in the selected recipe from the server and allows the display to display the discount information, and
the recipe print control section responds to an instruction to print out the selected recipe, the instruction being input through the operating section by the customer, to allow the printing section to print, together with the recipe, a discount code for the promotional product based on the discount information.

3. The store system according to claim 2, wherein when the customer inputs an instruction to acquire discount information on another product through the operating section, the recipe display control section responds to the instruction, thus acquiring the discount information on another one of the promotional products contained in the selected recipe from the server and allowing the display to display, in place of the discount information previously displayed on the display, the newly acquired discount information on the other promotional product.

4. The store system according to claim 1, wherein if the data on the promotional product-related recipe indicates a plurality of promotional product-related recipes, the recipe display control section allows the display to first display, among the plurality of promotional product-related recipes, a promotional product-related recipe containing a large number of the promotional products.

5. The store system according to claim 1, wherein
the recipe is a recipe for a dish having information on nutrient balance as additional information,
the server further comprises a combined sale product designating section that designates, as a combined sale product, a product for compensating for loss of a nutrient in the promotional product-related recipe, and
when the customer selects any recipe through the operating section, the recipe display control section of the customers' terminal acquires information on the combined sale product related to the recipe from the server and allows the display to display the information on the combined sale product together with the recipe.

6. The store system according to claim 5, wherein
the recipe database contains, as preliminary information for each of the recipes stored in the recipe database, a radar chart representing respective contents of nutrients contained in a dish to be cooked from the recipe, and
the combined sale product designating section refers to the radar chart to identify a nutrient in which the promotional product-related recipe is deficient, and designates, from among the products available for sale in the store, a product rich in the nutrient as the combined sale product based on the inventory statuses of the products being managed by the inventory management section.

7. The store system according to claim 5, wherein the combined sale product designating section designates the combined sale product from among the promotional products.

8. The store system according to claim 1, wherein
the recipe is a recipe for a dish,
the customers' terminal further comprises a photograph transfer section that acquires data of a dish photograph from a user terminal carried by the customer and transmits the data to the server,
the server further comprises a recipe identifying section that receives the data of the dish photograph from the customers' terminal and performs processing of image matching for the dish photograph to identify a recipe corresponding to the dish photograph from among the plurality of recipes stored in the recipe database, and
the recipe display control section of the customers' terminal acquires the identified recipe from the server and allows the display to display the recipe.
